(19) United States
(12) Patent Application Publication
(10) Pub. No.: US 2020/0201481 A1
(43) Pub. Date: Jun. 25, 2020

(54) TOUCH SENSOR AND MANUFACTURING METHOD THEREFOR

(71) Applicant: DONGWOO FINE-CHEM CO., LTD., Jeollabuk-do (KR)

(72) Inventors: Jin Koo Lee, Gyeonggi-do (KR); Keon Kim, Gyeonggi-do (KR); Byung Jin Choi, Gyeonggi-do (KR)

(21) Appl. No.: 16/077,192

(22) PCT Filed: Dec. 29, 2016
(86) PCT No.: PCT/KR2016/015490

§ 371 Date: Aug. 10, 2018

(30) Foreign Application Priority Data
Feb. 19, 2016 (KR) 10-2016-0019547

(51) Int. Cl. G06F 3/044

(52) U.S. Cl. CPC G06F 3/0443; G06F 2203/04107; G06F 2203/04103

(57) ABSTRACT

The present invention relates to a touch sensor and a manufacturing method therefor. A touch sensor, according to the present invention, comprises: a base layer; a touch sensor layer formed on the base layer; a connection line unit electrically connected to the touch sensor layer; a bonding pad unit electrically connected to the connection line unit; a first protection layer formed on the touch sensor layer and the connection line unit; and a second protection layer formed on the bonding pad unit and having a thickness thinner than the first protection layer. According to the present invention, there is an effect of enhancing durability and simultaneously improving adhesion characteristics between a bonding pad and an FPC.

### TECHNICAL FIELD

The present invention relates to a touch sensor and a manufacturing method thereof, and more particularly, relates to a touch sensor and a manufacturing method thereof capable of increasing the durability and enhancing the bonding property between bonding pads and flexible printed circuit (FPC) at the same time.

### BACKGROUND ART

Generally, touch sensor is a device detecting the location of a touch in response to a touch when a user touches an image being displayed on a screen with a finger, a touch pen, or the like; for example, it is manufactured in a structure wherein it is attached to a display device such as a liquid crystal display (LCD), an organic light-emitting diode (OLED), and the like.

The touch information obtained by the touch sensor is delivered to the signal processing unit and processed thereby, and generally, the touch sensor and the signal processing unit are electrically connected via the flexible printed circuit (FPC). Bonding pads are provided in the touch sensor for electrical connection with the FPC, and a protective layer is provided over the entire region except the bonding pads in order to protect the constituting elements of the touch sensor from the external physical factors.

According to the prior arts, the FPC and the bonding pads provided in the touch sensor is bonded using an anisotropic conductive film (ACF) as an intermediate material, however, there is a problem in that a bonding failure may occur due to the height difference between the bonding pads and the protective layer.

In other words, as the thickness of the protective layer is increased more in order to enhance the durability of the touch sensor, the height difference between the bonding pads and the protective layer becomes larger, and consequently, the possibility of bonding failure between the bonding pads and the FPC is increased.

And, if the thickness of the protective layer is decreased in order to enhance the bonding strength between the bonding pads and the FPC, there is a problem in that the durability of the touch sensor is degraded.

### PRIOR-ART DOCUMENT

### Patent Document

1. Korea Unexamined Patent Publication No. 2009-0119600 (Publication Date: Nov. 19, 2009, Title: Liquid crystal display device integrated touch panel)

2. Korea Unexamined Patent Publication No. 2011-0062469 (Publication Date: Jun. 10, 2011, Title: Flat panel display integrated touch screen panel)

### DISCLOSURE OF INVENTION

### Technical Problem

A technical objective of the present invention is to provide a touch sensor and a manufacturing method thereof capable of enhancing the durability and the bonding property between the bonding pads and the FPC at the same time.

### Solution to Problem

A touch sensor according to the present invention comprises: a base material; a touch sensing layer formed on the base material; a connecting line portion electrically connected to the touch sensing layer; a boding pad portion electrically connected to the connecting line portion; a first protective layer formed on the touch sensing layer and the connecting line portion; and a second protective layer, formed on the bonding pad portion, having a thickness thinner than the first protective layer.

In a touch sensor according to the present invention, it is characterized in that the second protective layer is formed on a part of the upper surface of unit pads constituting the bonding pad portion, and on the base material between the unit pads.

In a touch sensor according to the present invention, it is characterized in that the second protective layer is formed on the base material between the unit pads constituting the bonding pad portion.

In a touch sensor according to the present invention, it is characterized in that the second protective layer is formed in a way that at least a part of the upper surface of the unit pads constituting the bonding pad portion is exposed.

In a touch sensor according to the present invention, it is characterized in that the thickness of the first protective layer is in the range of 1.5 μm to 10 μm.

In a touch sensor according to the present invention, it is characterized in that the thickness of the second protective layer is in the range of 0.5 μm to 1.5 μm.

In a touch sensor according to the present invention, it is characterized in that the second protective layer includes an organic insulating material.

In a touch sensor according to the present invention, it is characterized in that the first protective layer and the second protective layer are formed of same material.

A manufacturing method of a touch sensor according to the present invention comprises the steps of: forming a touch sensing layer forming a touch sensing layer on a base material; forming a connecting line portion and a bonding pad portion wherein a connecting line portion is formed so as to be electrically connected to the touch sensing layer, and a bonding pad portion is formed so as to be electrically connected to the connecting line portion; and forming a protective layer wherein a first protective layer is formed on the touch sensing layer and the connecting line portion, and a second protective layer having thickness thinner than the first protective layer is formed.

In a method for manufacturing a touch sensor according to the present invention, in the step of forming the protective layer, it is characterized in that the first protective layer and the second protective layer are formed by same process using a halftone mask.

In a method for manufacturing a touch sensor according to the present invention, in the step of forming the protective layer, it is characterized in that the second protective layer is formed on a part of the upper surface of unit pads constituting the bonding pad portion, and on the base material between the unit pads.

In a method for manufacturing a touch sensor according to the present invention, in the step of forming the protective layer, it is characterized in that the second protective layer is formed on the base material between the unit pads constituting the bonding pad portion.

In a method for manufacturing a touch sensor according to the present invention, in the step of forming the protective layer, it is characterized in that the second protective layer is formed in a way that at least a part of the upper surface of the unit pads constituting the bonding pad portion is exposed.

In a method for manufacturing a touch sensor according to the present invention, in the step of forming the protective layer, it is characterized in that the thickness of the first protective layer is formed to be in the range of 1.5 μm to 10 μm.

In a method for manufacturing a touch sensor according to the present invention, in the step of forming the protective layer, it is characterized in that the thickness of the second protective layer is formed to be in the range of 0.5 μm to 1.5 μm.

In a method for manufacturing a touch sensor according to the present invention, it is characterized in that the second protective layer includes an organic insulating material.

In a method for manufacturing a touch sensor according to the present invention, in the step of forming the protective layer, it is characterized in that the first protective layer and the second protective layer are formed of same material.

### Advantageous Effects of Invention

According to the present invention, there is an effect in that it is provided a touch sensor and a manufacturing method thereof capable of enhancing the durability and the bonding property between the bonding pads and the FPC at the same time.

### BRIEF DESCRIPTION OF DRAWINGS

FIG. 1 is a plan view of a touch sensor according to an exemplary embodiment of the present invention;

FIG. 2 is a cross-sectional view of a touch sensor according to an exemplary embodiment of the present invention;

FIG. 3 is a process flow diagram of a manufacturing method of a touch sensor according to an exemplary embodiment of the present invention; and

FIGS. 4 to 8 are the cross-sectional views of the processes of the manufacturing method of a touch sensor according to an exemplary embodiment of the present invention.

### MODE FOR THE INVENTION

As specific structural or functional descriptions for the embodiments according to the concept of the invention disclosed herein are merely exemplified for purposes of describing the embodiments according to the concept of the invention, the embodiments according to the concept of the invention may be embodied in various forms but are not limited to the embodiments described herein.

While the embodiments of the present invention are susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a preferred exemplary embodiment of the present invention will be described in detail with reference to the accompanying drawings.

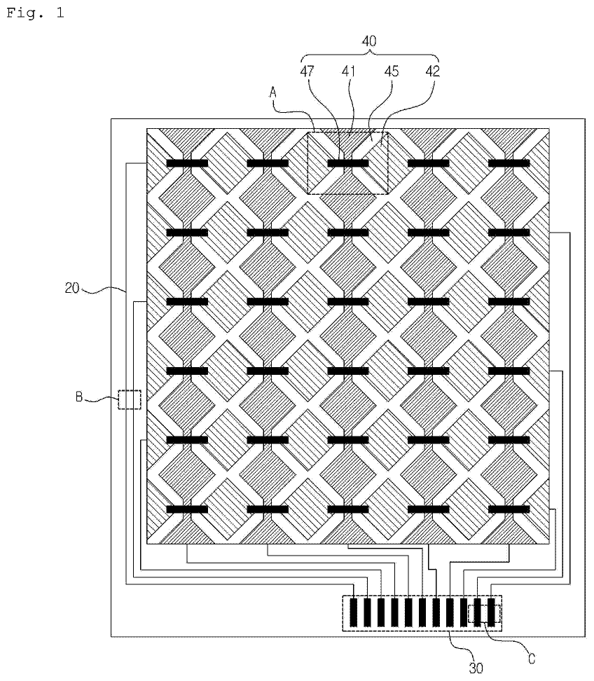

FIG. 1 is a plan view of a touch sensor according to an exemplary embodiment of the present invention

Referring to FIG. 1, a touch sensor according to an exemplary embodiment of the present invention can be classified into a display region and a non-display region with reference to whether the visual information is being displayed or not.

Display region is a region wherein images provided by the device coupled with the touch sensor are displayed and at the same time it is a region for detecting touch signal input from the user using a capacitance method, and in this display region, a touch sensing layer 40 including a plurality of sensing patterns 41 and 42 formed in the mutually crossed direction is formed.

In the non-display region located in the periphery of the display region, a connecting line portion 20 electrically connected to the touch sensing layer 40, and a bonding pad portion 30 connected to the connecting line portion 20 are formed. A flexible printed circuit (FPC) delivering a touch signal detected in the display region to a driving unit (not shown) is connected to the bonding pad portion 30.

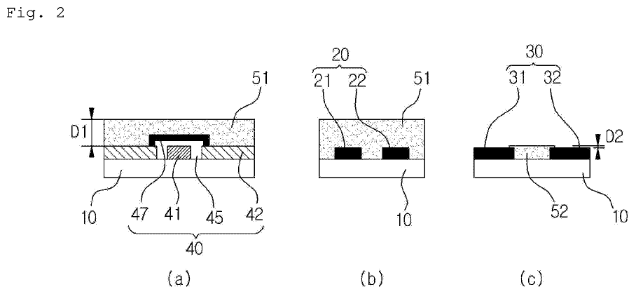

FIG. 2 is a cross-sectional view of a touch sensor according to an exemplary embodiment of the present invention.

Additionally referring to FIG. 2, a touch sensor according to an exemplary embodiment of the present invention comprises: a base material 10; a touch sensing layer 40; a connecting line portion 20; a bonding pad portion 30; a first protective layer 51; and a second protective layer 52.

The base material 10 is a base wherein the elements of the touch sensor are formed, and may be a transparent material made of a hard or a soft material.

The touch sensing layer 40 is formed on the base material 10, and it is an element for detecting touch signal input from a user.

The sensing patterns constituting the touch sensing layer 40 can be formed in an appropriate shape depending on the requirement of the electronic devices to be applied with the sensing patterns, for example, when they are applied to a touch screen panel, two types of patterns, one for detecting x-coordinate and another one for detecting y-coordinate, can be formed, but they are not limited to these types.

For example, the touch sensing layer 40 may comprise first sensing patterns 41, second sensing patterns 42, an insulating layer 45, and connecting patterns 47.

The first sensing patterns 41 are electrically connected to each other and formed along a first direction, and the second sensing patterns 42 are electrically isolated from each other and formed along a second direction, wherein the first direction and the second direction are crossing each other. For example, if the first direction is an x-direction, the second direction may be a y-direction.

The insulating layer 45 is formed between the first sensing patterns 41 and the second sensing patterns 42, and electrically insulates the first sensing patterns 41 from the second sensing patterns 42.

The connecting patterns 47 electrically connect the adjacent second sensing patterns 42.

As for the first sensing patterns 41, the second sensing patterns 42, and the connecting patterns 47, any transparent conductive material can be used without limitation, for example, it can be formed with materials selected from: metal oxides selected from the group comprising indium tin oxide (ITO), indium zinc oxide (IZO), indium zinc tin oxide (IZTO), aluminum zinc oxide (AZO), gallium zinc oxide (GZO), fluorine tin oxide (FTC), indium tin oxide-Ag-indium tin oxide (ITO-Ag-ITO), indium zinc oxide-Ag-indium zinc oxide (IZO-Ag-IZO), indium zinc tin oxide-Ag-indium zinc tin oxide (IZTO-Ag-IZTO), and aluminum zinc oxide-Ag-aluminum zinc oxide (AZO-Ag-AZO); metals selected from the group comprising gold (Au), silver (Ag), molybdenum (Mo), and APC; nano wires made of metal selected from the group comprising gold, silver, copper, and lead; carbon based materials selected from the group comprising carbon nano tube (CNT) and grapheme; and conductive polymer materials selected from the group comprising poly (3,4-ethylenedioxitiophene) (PEDOT) and polyaniline (PANI), and these can be used individually or in a mixture of more than two of them, and preferably, indium tin oxide may be used. Both a crystalline and a non-crystalline indium tin oxide are usable.

The thickness of the touch sensing layer 40 is not specifically limited; however, if possible, a thin film is preferred considering the flexibility of touch sensors. For example, the thickness of the touch sensing layer 40 is to be in the range of 0.01 μm to 5 μm, preferably, in the range of 0.03 μm to 0.5 μm.

For example, the first sensing patterns 41 and the second sensing patterns 42, mutually independent and constituting the touch sensing layer 40, may be patterns comprised of polygons like triangles, rectangles, pentagons, hexagons, heptagons or the like.

In addition, for example, the touch sensing layer 40 may comprise a regular pattern. The regular pattern means that the shape of the pattern possesses regularity. For example, the sensing patterns, mutually independent, may comprise a mesh-like shape such as rectangles or squares, or a pattern comprised of hexagons.

Also, for example, the sensing layer 40 may include an irregular pattern. An irregular pattern means that the shape of the pattern contains irregularity therein.

Also, for example, when the sensing patterns constituting the touch sensing layer 40 are formed with metal nano wires, carbon based materials, polymer based materials, and the like; the sensing patterns may have a network type structure. When the sensing patterns have a network type structure, since signals are sequentially transferred to the adjacent patterns contacted to each other, patterns having a high sensitivity can be implemented.

For example, the sensing patterns constituting the touch sensing layer 40 may be formed to have a single-layer structure or a multi-layer structure.

As for a material of the insulating layer 45 for insulating the first sensing patterns 41 and the second sensing patterns 42, any insulating material known to the art may be used without limitation, for example, metal oxides like silicon based oxides, photosensitive resin composites containing metal oxides or acrylic resins, or thermoplastic resin composites may be used. Or, the insulating layer 45 may be formed using inorganic materials such as silicon oxides (SiOx), and in this case, they can be formed using methods such as vacuum evaporation, sputtering, and the like.

The connecting line portion 20 is electrical lines electrically connecting the touch sensing layer 40 and the bonding pad portion 30. That is, the connecting line portion 20 electrically connects the first and second sensing patterns 41 and 42 to the bonding pad portion 30. For example, the connecting line portion 20 and the connecting patterns 47 constituting the touch sensing layer 40 may be same material.

The bonding pad portion 30 is electrically connected to the connecting line portion 20, and bonded to the flexible printed circuit (FPC) using an anisotropic conductive film (ACF) (not shown) as an intermediate material.

The first protective layer 51 is formed on the touch sensing layer 40 and the connecting line portion 20, and protects the touch sensing layer 40 and the connecting line portion 20 from the external physical factors.

More specifically, the protective layer 51 is formed with an insulating material, and formed in a way to cover the first sensing patterns 41, the second sensing patterns 42, an insulating layer 45, the connecting patterns 47, and connecting line portion 20, and it performs the function of insulating the touch sensing layer 40 and the connecting portion 20 from the outside and protecting thereof. For example, the first protective layer 51 may be formed to have a single-layer or multi-layers of more than two layers.

For example, the thickness of the first protective layer 51 is preferred to be in the range of 1.5 μm to 10 μm. If the thickness of the first protective layer 51 is less than 1.5 μm, the durability of the first protective layer 51 is degraded so that the elements constituting the touch sensor cannot be protected sufficiently from the external factors such as impact and the like; but if the thickness of the first protective layer 51 exceeds 10 μm, the uniformity of the first protective layer 51 is significantly degraded, thereby degrading the performance quality of the touch sensor.

The second protective layer 52 is formed on the bonding pad portion 30 and has a thickness thinner than the first protective layer 51.

In this way, if the second protective layer 52 is configured to have a thickness thinner than the first protective layer 51, the durability of the touch sensor is enhanced and the touch sensing layer 40 and the connecting line portion 20, which are beneath the first protective layer 51, can be sufficiently protected from the external physical factors, and at the same time, the bonding property between the bonding pad portion 30 and the FPC (not shown) is enhanced due to the reduction in the height difference between the second protective layer 52 and the bonding pad portion 30.

For example, it is preferred that the thickness of the second protective layer 52 is in the range of 0.5 μm to 1.5 μm. If the thickness of the second protective layer 52 is less than 0.5 μm, the outer perimeter of the unit pads constituting the bonding pad portion 30 cannot be protected sufficiently, but if the thickness of the second protective layer 52 exceeds 1.5 μm, a bonding failure in FPC may occur due to the height difference between the second protective layer 52 and the unit pads constituting the bonding pad portion 30.

For example, an organic insulation film can be used as a material for the second protective layer 52, and above all, it may be the one formed with a hardening composite containing a polyol and a melamine curing agents, but not limited to these examples.

As for the specific types of polyol, polyether glycol derivatives, polyester glycol derivatives, polycaprolactone glycol derivatives, and the like can be taken as examples thereof, but not limited to these examples.

As for the specific types of melamine curing agent, methoxy methyl melamine derivatives, methyl melamine derivatives, butyl melamine derivatives, isobutoxy melamine derivatives, butoxy melamine derivatives, and the like can be taken as examples thereof, but not limited to these examples.

As for other example, the second protective layer 52 can be formed with organo-inorgano hybrid curable composites, and using both organic compound and inorganic compound is desirable in that the cracks occurring while peeling off can be reduced.

As for an organic compound, the above described components can be used, and as for an inorganic material, silica based nano particles, silicon based nano particles, glass nano fibers, and the like can be taken as examples thereof, but not limited to these examples.

For example, the first protective layer 51 and the second protective layer 52 may be formed of same material.

For example, the second protective layer 52 may be formed on a part of the upper surface of unit pads constituting the bonding pad portion 30 and on the base material 10 between the unit pads; or formed on the base material 10 between the unit pads constituting the bonding pad portion 30; or formed in a way that at least a part of the upper surface of the unit pads constituting the bonding pad portion 30 is exposed.

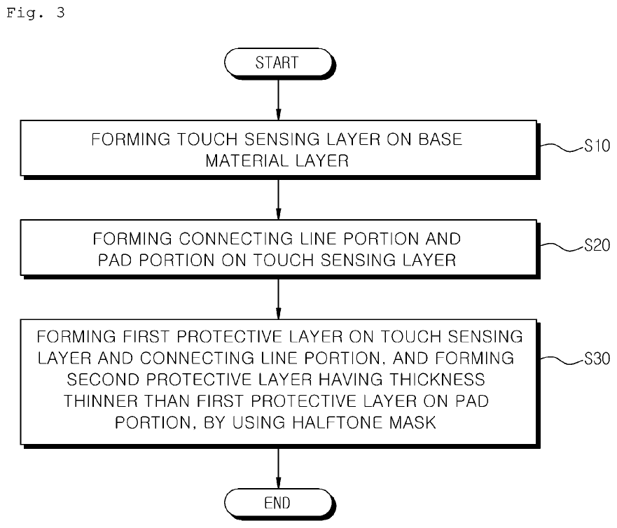

FIG. 3 is a process flow diagram of a manufacturing method of a touch sensor according to an exemplary embodiment of the present invention; and FIGS. 4 to 8 are the cross-sectional views of the processes of the manufacturing method of a touch sensor according to an exemplary embodiment of the present invention. In FIGS. 4 to 8, the cross-sectional views of region A, B, and C in FIG. 1 are comparatively illustrated. For example, in FIGS. 4 to 8, (a) is a cross-sectional view of region A, (b) is a cross-sectional view of region B, and (c) is a cross-sectional view of region C.

Referring to FIG. 3, a manufacturing method of a touch sensor according to an exemplary embodiment of the present invention comprises the steps of: forming a touch sensing layer S10; forming a connecting line portion and a bonding pad portion S20; and forming a protective layer S30.

Referring to FIGS. 3 to 6, in step S10 of forming a touch sensing layer, a process of forming the touch sensing layer 40 on the base material 10 is performed.

The touch sensing layer 40 is an element for detecting touch signal input from a user.

For example, the sensing patterns constituting the touch sensing layer 40 can be formed in an appropriate shape depending on the requirement of the electronic devices to be applied with the sensing patterns, for example, when they are applied to a touch screen panel, two types of patterns, one for detecting x-coordinate and another one for detecting y-coordinate, can be formed, but they are not limited to these types.

First, as illustrated in FIG. 4, on the base material 10, processes of forming the first sensing patterns 41 connected to each other along the first direction, and forming the second sensing patterns 42 isolated from each other along the second direction are performed. For example, if the first direction is x-direction, the second direction can be y-direction.

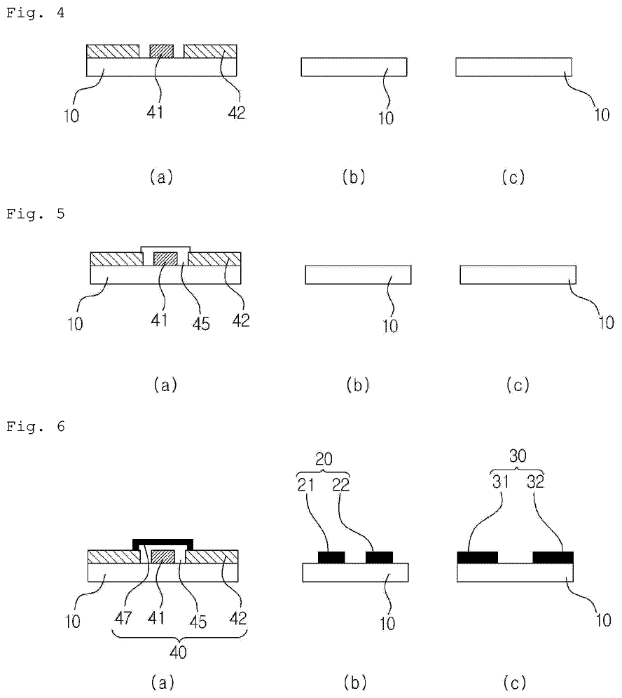

Next, as illustrated in FIG. 5, a process of forming the isolating layer 45 between the first sensing patterns 41 and the second sensing patterns 42 is performed.

The insulating layer 45 electrically isolates the first sensing patterns 41 and the second sensing patterns 42.

Next, as illustrated in FIG. 6, a process of forming connecting patterns 47 electrically connecting the adjacent second sensing patterns 42 is performed.

As for the first sensing patterns 41, the second sensing patterns 42, and the connecting patterns 47, any transparent conductive material can be used without limitation, for example, it can be formed with materials selected from: metal oxides selected from the group comprising indium tin oxide (ITO), indium zinc oxide (IZO), indium zinc tin oxide (IZTO), aluminum zinc oxide (AZO), gallium zinc oxide (GZO), fluorine tin oxide (FTC), indium tin oxide-Ag-indiumtinoxide (ITO-Ag-ITO),indiumzincoxide-Ag-indium zinc oxide (IZO-Ag-IZO), indium zinc tin oxide-Ag-indium zinc tin oxide (IZTO-Ag-IZTO), and aluminum zinc oxide-Ag-aluminum zinc oxide (AZO-Ag-AZO); metals selected from the group comprising gold (Au), silver (Ag), molybdenum (Mo), and APC; nano wires made of metal selected from the group comprising gold, silver, copper, and lead; carbon based materials selected from the group comprising carbon nano tube (CNT) and grapheme; and conductive polymer materials selected from the group comprising poly (3,4-ethylenedioxitiophene) (PEDOT) and polyaniline (PANI), and these can be used individually or in a mixture of more than two of them, and preferably, indium tin oxide may be used. Both a crystalline and a non-crystalline indium tin oxide are usable.

The thickness of the touch sensing layer 40 is not specifically limited; however, if possible, a thin film is preferred considering the flexibility of touch sensors. For example, the thickness of the touch sensing layer 40 is to be in the range of 0.01 μm to 5 μm, preferably, in the range of 0.03 μm to 0.5 μm.

For example, the first sensing patterns 41 and the second sensing patterns 42, mutually independent and constituting the touch sensing layer 40, may be patterns comprised of polygons like triangles, rectangles, pentagons, hexagons, heptagons or the like.

In addition, for example, the touch sensing layer 40 may comprise a regular pattern. The regular pattern means that the shape of the pattern possesses regularity. For example, the sensing patterns, mutually independent, may comprise a mesh-like shape such as rectangles or squares, or a pattern comprised of hexagons.

Also, for example, the sensing layer 40 may include an irregular pattern. An irregular pattern means that the shape of the pattern contains irregularity therein.

Also, for example, when the sensing patterns constituting the touch sensing layer 40 are formed with metal nano wires, carbon based materials, polymer based materials, and the like; the sensing patterns may have a network type structure. When the sensing patterns have a network type structure, since signals are sequentially transferred to the adjacent patterns contacted to each other, patterns having a high sensitivity can be implemented.

For example, the sensing patterns constituting the touch sensing layer 40 may be formed to have a single-layer structure or a multi-layer structure.

As for a material of the insulating layer 45 for insulating the first sensing patterns 41 and the second sensing patterns 42, any insulating material known to the art may be used without limitation, for example, metal oxides like silicon based oxides, photosensitive resin composites containing metal oxides or acrylic resins, or thermoplastic resin composites may be used. Or, the insulating layer 45 may be formed using inorganic materials such as silicon oxides (SiOx), and in this case, they can be formed using methods such as vacuum evaporation, sputtering, and the like.

Referring to FIGS. 3 and 6, in step S20 of forming a connecting line portion and a bonding pad portion, a process of forming a connecting line portion 20 so as to be electrically to the touch sensing layer 40, and a process of forming a bonding pad portion 30 so as to be electrically connected to the connecting line portion 20, are performed.

For example, step S20 of forming a connecting line portion and a bonding pad portion can be simultaneously performed with step of forming connecting patterns, and the connecting line portion 20 and the bonding pad portion 30 may be formed of same material as the connecting patterns 47.

Referring to FIGS. 3, 7, and 8, in step S30 of forming a protective layer, a process of forming the first protective layer 51 on the touch sensing layer 40 and the connecting line portion 20 is performed, and a process of forming the second protective layer 52 having a thickness thinner than the first protective layer 51 on the bonding pad portion 30 is performed.

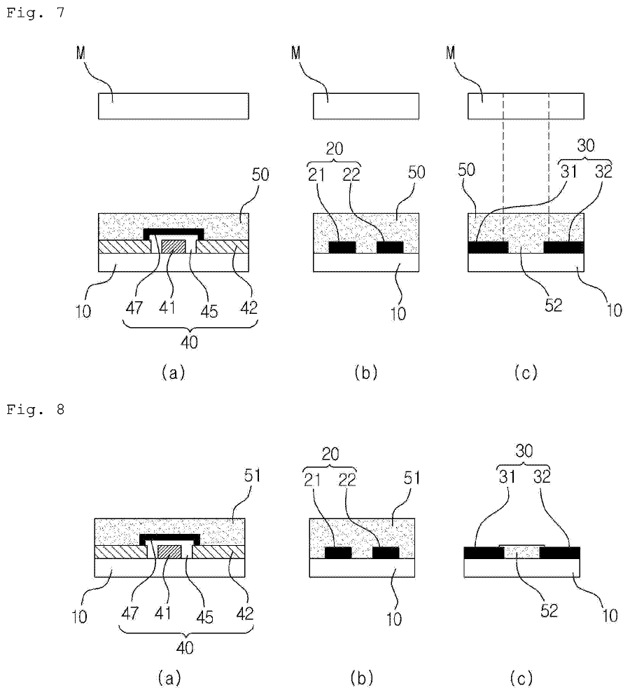

First, as illustrated in FIG. 7, a protective layer forming material layer 50 is formed on the entire surface of the touch sensing layer 40, the connecting line portion 20, and the bonding pad portion 30, and after disposing a halftone mask M on the protective layer forming material layer 50, a process of differentially exposing the protective layer forming material layer 50 to light using the halftone mask M and developing thereof is performed. The halftone mask M has a light transmissivity pattern corresponding to the shape of a targeted pattern. That is, when the light output from the light exposing device is arrived at the halftone mask M, the light arrived at the halftone mask M passes through the halftone mask M corresponding to the light transmissivity pattern and arrived at the protective layer forming material layer 50, therefore, the protective layer forming material layer 50 is exposed to light corresponding to the light transmissivity pattern of the halftone mask M.

For example, considering the thicknesses of the first protective layer 51 and the second protective layer 52 to be formed finally, the protective layer forming material layer 50 can be formed to have a thickness about 10 μm.

If the protective layer forming material layer 50 is differentially exposed to light using the halftone mask M and developed, as illustrated in FIG. 8, the first protective layer 51 formed on the touch sensing layer 40 and the connecting line portion 20, and the second protective layer 52, formed on the bonding pad portion 30, having a thickness thinner than the first protective layer 51, are obtained.

For example, the protective layer 51 may be formed with an insulating material, and formed in a way to cover the first sensing patterns 41, the second sensing patterns 42, an insulating layer 45, the connecting patterns 47, and connecting line portion 20, and it performs the function of insulating the touch sensing layer 40 and the connecting portion 20 from the outside and protecting thereof. For example, the first protective layer 51 may be formed to have a single-layer or multi-layers of more than two layers.

For example, the thickness of the first protective layer 51 is preferred to be in the range of 1.5 μm to 10 μm. If the thickness of the first protective layer 51 is less than 1.5 μm, the durability of the first protective layer 51 is degraded so that the elements constituting the touch sensor cannot be protected sufficiently from the external factors such as impact and the like; but if the thickness of the first protective layer 51 exceeds 10 μm, the uniformity of the first protective layer 51 is significantly degraded, thereby degrading the performance quality of the touch sensor.

The second protective layer 52 is formed on the bonding pad portion 30 and has a thickness thinner than the first protective layer 51.

In this way, if the second protective layer 52 is configured to have a thickness thinner than the first protective layer 51, the durability of the touch sensor is enhanced and the touch sensing layer 40 and the connecting line portion 20, which are beneath the first protective layer 51, can be sufficiently protected from the external physical factors, and at the same time, the bonding property between the bonding pad portion 30 and the FPC (not shown) is enhanced due to the reduction in the height difference between the second protective layer 52 and the bonding pad portion 30.

For example, it is preferred that the thickness of the second protective layer 52 is in the range of 0.5 μm to 1.5 μm. If the thickness of the second protective layer 52 is less than 0.5 μm, the outer perimeter of the unit pads constituting the bonding pad portion 30 cannot be protected sufficiently, but if the thickness of the second protective layer 52 exceeds 1.5 μm, a bonding failure in FPC may occur due to the height difference between the second protective layer 52 and the unit pads constituting the bonding pad portion 30.

For example, an organic insulation film can be used as a material for the second protective layer 52, and above all, it may be the one formed with a hardening composite containing a polyol and a melamine curing agents, but not limited to these examples.

As for the specific types of polyol, polyether glycol derivatives, polyester glycol derivatives, polycaprolactone glycol derivatives, and the like can be taken as examples thereof, but not limited to these examples.

As for the specific types of melamine curing agent, methoxy methyl melamine derivatives, methyl melamine derivatives, butyl melamine derivatives, isobutoxy melamine derivatives, butoxy melamine derivatives, and the like can be taken as examples thereof, but not limited to these examples.

As for other example, the second protective layer 52 can be formed with organo-inorgano hybrid curable composites, and using both organic compound and inorganic compound is desirable in that the cracks occurring while peeling off can be reduced.

As for an organic compound, the above described components can be used, and as for an inorganic material, silica based nano particles, silicon based nano particles, glass nano fibers, and the like can be taken as examples thereof, but not limited to these examples.

For example, the first protective layer 51 and the second protective layer 52 may be formed of same material.

For example, the second protective layer 52 may be formed on a part of the upper surface of unit pads constituting the bonding pad portion 30 and on the base material 10 between the unit pads; or formed on the base material 10 between the unit pads constituting the bonding pad portion 30; or formed in a way that at least a part of the upper surface of the unit pads constituting the bonding pad portion 30 is exposed.

As previously described in detail, according to the present invention, there is an effect in that it is provided a touch sensor and a manufacturing method thereof capable of enhancing the durability and the bonding property between the bonding pads and the FPC at the same time.

More specifically, there is an effect in that it is provided a touch sensor and a manufacturing method thereof wherein the durability of the touch sensor is enhanced, and the touch sensing layer and the connecting line portion located beneath the first protective layer are sufficiently protected from the external physical factors, and at the same time, the bonding property between the bonding pad portion and the FPC (not shown) is enhanced due to the reduction in the height difference between the second protective layer and the bonding pad portion.

### DESCRIPTION OF SYMBOLS

10: base material
20: connecting line portion
30: bonding pad portion
40: touch sensing layer
41: first sensing patterns
42: second sensing patterns
45: insulating layer
47: connecting patterns
51: first protective layer
52: second protective layer
M: halftone mask
S10: step of forming touch sensing layer
S20: step of forming connecting line portion and bonding pad portion
S30: step of forming protective layer

1. A touch sensor comprising:
a base material;
a touch sensing layer formed on the base material;
a connecting line portion electrically connected to the touch sensing layer;
a boding pad portion electrically connected to the connecting line portion;
a first protective layer formed on the touch sensing layer and the connecting line portion; and
a second protective layer, formed on the bonding pad portion, having a thickness thinner than the first protective layer.

2. The touch sensor according to claim 1,
wherein the second protective layer is formed on a part of the upper surface of unit pads constituting the bonding pad portion, and on the base material between the unit pads.

3. The touch sensor according to claim 1,
wherein the second protective layer is formed on the base material between the unit pads constituting the bonding pad portion.

4. The touch sensor according to claim 1,
wherein the second protective layer is formed in a way that at least a part of the upper surface of the unit pads constituting the bonding pad portion is exposed.

5. The touch sensor according to claim 1,
wherein the thickness of the first protective layer is in the range of 1.5 μm to 10 μm.

6. The touch sensor according to claim 1,
wherein the thickness of the second protective layer is in the range of 0.5 μm to 1.5 μm.

7. The touch sensor according to claim 1,
wherein the second protective layer includes an organic insulating material.

8. The touch sensor according to claim 1,
wherein the first protective layer and the second protective layer are formed of same material.

9. A manufacturing method of a touch sensor comprising the steps of:
forming a touch sensing layer forming a touch sensing layer on a base material;
forming a connecting line portion and a bonding pad portion wherein a connecting line portion is formed so as to be electrically connected to the touch sensing layer, and a bonding pad portion is formed so as to be electrically connected to the connecting line portion; and
forming a protective layer wherein a first protective layer is formed on the touch sensing layer and the connecting line portion, and a second protective layer having thickness thinner than the first protective layer is formed.

10. The manufacturing method of a touch sensor according to claim 9,
wherein in the step of forming the protective layer, the first protective layer and the second protective layer are formed by same process using a halftone mask.

11. The manufacturing method of a touch sensor according to claim 9,
wherein in the step of forming the protective layer, the second protective layer is formed on a part of the upper surface of unit pads constituting the bonding pad portion, and on the base material between the unit pads.

12. The manufacturing method of a touch sensor according to claim 9,
wherein in the step of forming the protective layer, the second protective layer is formed on the base material between the unit pads constituting the bonding pad portion.

13. The manufacturing method of a touch sensor according to claim 9,
wherein in the step of forming the protective layer, the second protective layer is formed in a way that at least a part of the upper surface of the unit pads constituting the bonding pad portion is exposed.

14. The manufacturing method of a touch sensor according to claim 9,
wherein in the step of forming the protective layer, the thickness of the first protective layer is formed to be in the range of 1.5 μm to 10 μm.

15. The manufacturing method of a touch sensor according to claim 9,
wherein in the step of forming the protective layer, the thickness of the second protective layer is formed to be in the range of 0.5 μm to 1.5 μm.

16. The manufacturing method of a touch sensor according to claim 9,
wherein the second protective layer includes an organic insulating material.

17. The manufacturing method of a touch sensor according to claim 9,
wherein in the step of forming the protective layer, the first protective layer and the second protective layer are formed of same material.
